(19) United States
(12) Patent Application Publication
(10) Pub. No.: US 2002/0138398 A1
(43) Pub. Date: Sep. 26, 2002

(54) Automated bandwidth exchange node system

(76) Inventors: Dan M. Kalin, Sterling, VA (US); John A. Mullan, Leesburg, VA (US)

Correspondence Address: JONES VOLENTINE, L.L.C., Suite 150, 12200 Sunrise Valley Drive, Reston, VA, 20191, US

(21) Appl. No.: 09/847,291

(22) Filed: May 3, 2001

Related U.S. Application Data
(60) Provisional application No. 60/278,438, filed on Mar. 26, 2001.

(51) Int. Cl. G06F 17/60

(52) U.S. Cl. 705/37; 705/40

(57) ABSTRACT

A method and apparatus are provided in an integrated platform for automatic network data transport, procurement contracting, provisioning, contract fulfillment, customized billing feeds, and securing of bandwidth derivative financial instruments. This is achieved through the use of multiple bandwidth exchange nodes within carrier-neutral facilities at geographically separate locations. The system and apparatus provide contracted bandwidth between nodes as negotiated by virtual user and carrier agents, enabling for the securing of capacity futures contracts as well as a real-time means to determine current market pricing for bandwidth contracts and derivatives. This system creates the basis for a liquid bandwidth commodity and derivatives marketplace.

This application relies for priority upon U.S. Provisional Patent Application No. 60/278,438, filed on Mar. 26, 2001, the contents of which are herein incorporated by reference in their entirety.

### BACKGROUND OF THE INVENTION

The present invention relates to the fields of telecommunications transport provisioning and bandwidth commodity futures trading. In particular, the present invention specifically provides a method for automatically creating and provisioning flexible point-to-point bandwidth contracts.

The rapid growth of global demand for data network services coupled with the rapid development of data transmission technologies have created the need for a more flexible approach to the procurement and provisioning of telecommunications facilities.

The traditional model of delivering telecommunications services stems from the manpower-intensive model of the public utility telephone company. The primary basis for the modern telecommunications provider processes and practices stems from the time when all communications were of a circuit switched nature, starting with the local switchboard operator. While the switching was fairly quickly relegated to mechanical devices, providing services remained a very large scale enterprise involving the participation of many people to initiate and maintain telecommunications services.

Governmental regulation also played its role in making sure that telecommunications services had little liquidity. The processes and methods that enabled a licensed monopolist's compliance with governmental regulation are not suitable for a more dynamic marketplace. The traditional model requires lengthy intervals for the installation of services, long term contracts, inflexible pricing, and offers little or no choice of service providers.

However, telecommunications has moved away from a circuit-switched environment to a packet-switched digital data environment. This has added a requirement of bursty bandwidths. “Bursty” bandwidths means that networks do not require a fixed amount of bandwidth, since network traffic loading can fluctuate greatly within any 24 hour period. Rather, the required bandwidth will change over time along with network traffic.

Due to the reliance of telecommunications providers on long term contracts, which are not flexible, network administrators are forced to either compromise network performance by purchasing less than peak demand amounts of transport bandwidth, or to purchase bandwidth sized for peak loads that leave large periods of time where the purchased bandwidth would be underused.

To address this issue, several types of new telecommunications technologies were introduced in the early 1990s, Frame Relay and Asynchronous Transfer Mode. Both products were designed to account for the bursty nature of data telecommunications, by selling a reduced normal bandwidth facility with the ability to increase bandwidth during times of increased customer network loading.

Unfortunately, these technologies were deployed using the same types of sales, order provisioning, and billing processes as had been used previously by telecommunications providers. As a result, customers are still locked in to long term contracts (generally one year minimum), and installation intervals for large scale circuits s remain in the sixty (60) to ninety (90) day range.

To date, telecommunications transport technologies have experienced rapid development and it is expected that this will continue at a rapid pace. However, the same sales, order provisioning, and billing processes continue to respond to this new demand for capacity with the same installation intervals. But given the current technology, there is little technical reason why circuit provisioning cannot be done in less than an hour.

A new development has been the proliferation of carrier and data co-location facilities. In these facilities, large or medium-sized companies centrally locate some of their network server and storage assets. Many companies have the need to transport data from one of these locations to another in a geographically separate location. These needs are often cyclical in nature, and the long intervals to provision bandwidth between facilities do not support economic network performance.

Furthermore, with demand for bandwidth increasing in excess of 50% per year, it is very difficult to accurately gauge future network requirements for bandwidth, leading to over-provisioning and wasted bandwidth.

With the development of the Internet, companies involved in Internet related businesses will often have demands for staggering amounts of bandwidth, for an hour or two, and relatively lower amounts during the normal course of doing business. The current provisioning model does not easily support this type of activity.

Cross connect switching technology is well developed and quite sophisticated at this time. Carriers are able to remotely provision, via multiple cross connect switches, flexible port-to-port bandwidth within their networks in real time if they so desire. They do not however, because the current sales-to-operational circuit cycle consists of the many, non-integrated processes which prevent implementation efficiency.

Furthermore, carriers currently have no incentive to reduce economic friction when providing services. In fact, carriers spend significant amounts of capital to insure that customers are provided a “sticky” service, i.e., to make it difficult to change carriers or to replace the services that they provide with substitutes. Carriers also discourage the concept of short term or assignable contracts, which are key to development of a liquid commodity.

For that reason, recent attempts by carriers and some independent trading companies to create a bandwidth commodity exchange have been troubled by lack of liquidity, as the products sold have been anything but a commodity. Lack of standard contracts, enforceable penalties for non-performance, or guidelines on quality of service have prevented a liquid bandwidth commodity or derivatives market from being successful.

The present invention provides an integrated platform for bandwidth trading, provisioning, and billing by setting a standard contract, with enforceable standards of service, where the interval between contract negotiation and full operation can less than ten minutes. Furthermore, future capacity can be contracted with the ability to assign the contract to a third party, leading to the support for a bandwidth derivatives marketplace.

### SUMMARY OF THE INVENTION

The present invention provides a method and apparatus for automatic network data transport contracting, provisioning, contract fulfillment, billing, and securing of bandwidth derivative financial instruments. The invention uses multiple bandwidth exchange nodes located within carrier neutral co-location facilities and incorporates a means of cross connect switch fabric within each node to provision bandwidth.

The present invention performs all of the above functions without the need for real-time human intervention, thus greatly increasing the efficiency of bandwidth transactions.

As embodied by the present invention, a uniform standard for bandwidth contracts is established contractually by the operator of a bandwidth exchange node system with potential bandwidth users and carriers. This standard details a typical contract interval, performance service level agreements, billing metrics, contract assignability, and agreement to be contractually bound by the use of virtual agents. The operator establishes bandwidth exchange nodes between multiple carrier-neutral co-location facilities.

Users of bandwidth may purchase ports on the bandwidth exchange node at all locations where a need for bandwidth between nodes will be needed. Users may also connect to the bandwidth exchange node system through their virtual user agent, which can negotiate and contract for port-to-port bandwidth between nodes.

Carriers may also provision multiple circuits between all nodes port-to-port where there is a user need for bandwidth. Multiple carriers may provide contract-defined transport services between predefined nodes. Carriers may connect their virtual carrier agent to the bandwidth exchange node system, which negotiate and contract for the supply of port-to-port bandwidth between nodes.

The carrier and user virtual agents are preferably expert systems software algorithms, which are predefined according to the specific requirements of each party. While the system is operating, each virtual agent performs as it has been previously programmed, automatically purchasing and selling bandwidth. Carriers and users are able to modify the virtual agents as required by their needs, but are not anticipated to directly contract with human intervention in real-time, due to the dynamic nature of the system, although nothing prevents that functionality.

The virtual agents provide offers to sell and offers to buy specific contracts which are defined by origin and termination nodes, bandwidth and modality, and specific contract interval. Each origin and termination node pair defines a set of bandwidth marketplaces which include separate sub-markets for each standard bandwidth and modality variation.

The virtual user agent provides a bid to purchase a specified bandwidth between origin and termination nodes at a specified contract interval timeslot. The virtual carrier agent provides offers to sell specified bandwidth between the same specified bandwidth between the same origin and termination nodes at the same specified contract interval timeslot. If the bid price is greater than or equal to an existing offer a contract is concluded. The contract price would be the offer price closed. If there are no offers equal to or less than the bids, no contracts would be concluded.

The virtual agents receive continuous data feeds concerning each specific marketplace in which they participate, either as a user or as a carrier. Examples of such data is a listing of all current offers and bids, carriers, last contract concluded, etc. The virtual agents review the information against the constraints of their expert programs and make changes to their bids or offers as appropriate. The virtual agents also receive updates from their respective networks, which can revise demand and supply parameters in real-time, or make changes to the virtual agent expert programming.

The contract concluded is for a set price, for a specific contract interval, e.g., between a first user port and a third carrier port at the origin bandwidth exchange node to the first user port and the third carrier port at the destination bandwidth exchange node for a specified bandwidth modality. The concluded contract can assigned to other users, supporting the creation of derivative financial instruments which can be traded in a commodity exchange. The system can accept such assignment up to a short period prior to the contract interval to be provisioned. The assigned contract owner must have port access at both termination and originating bandwidth exchange nodes in order to take delivery of the contracted bandwidth, but nothing prevents financial institutions from taking a position in the derivatives marketplace, based on the underlying commodity, without a means of service delivery. Each specific marketplace provides continuous data feeds to participating derivatives exchanges, the same as that provided to the virtual agents.

As the contract interval approaches, the contract provisioning system readies both the originating and terminating bandwidth exchange nodes for the cross connect changes appropriate to the contract requirements of each separate contract. The system activity involves synchronous system-wide switching of each contracted circuit, contract service level compliance monitoring, contract fulfillment monitoring, archival of compliance statistics, and real-time cross connect changes to overcome a carrier upset condition which cannot be overcome by the carrier itself. As each contract is fulfilled, the contract provisioning system communicates fulfillment and compliance statistics to the contract billing module.

The contract billing module prepares custom billing data feeds to all carriers that have provided service during the interval, and maintains contract records archives for audit purposes. Carriers generally have unique billing system requirements, and the system will be able to export billing records in accordance with each carrier's unique requirements. The carriers would be able to prepare billing statements for all users, who have contracted service, according to their own proprietary system.

### BRIEF DESCRIPTION OF THE DRAWINGS

FIG. 1 is a diagram of a bandwidth exchange node using the method and apparatus of a preferred embodiment of the present invention;

FIG. 2 is a functional diagram of the smallest complete bandwidth exchange node circuit using the method and apparatus of a preferred embodiment of the present invention;

FIG. 3 is a functional diagram of a bandwidth exchange node circuit using the method and apparatus of another preferred embodiment of the present invention;

FIG. 4 is a process diagram which details the automated market controller portion of a bandwidth exchange node using the method and apparatus of a preferred embodiment of the present invention;

FIG. 5 is a process flow diagram of a virtual user agent cycle according to a preferred embodiment of the present invention;

FIG. 6 is a process flow diagram of a virtual carrier agent cycle according to a preferred embodiment of the present invention;

FIG. 7 is a process flow diagram of a dynamic circuit marketplace according to a preferred embodiment of the present invention;

FIGS. 8A and 8B are a block diagram of the dynamic circuit marketplace process architecture;

FIG. 9 is a process flow diagram of a marketplace contracts cycle according to a preferred embodiment of the present invention;

FIG. 10 is a process flow diagram of a contract provisioning cycle according to a preferred embodiment of the present invention; and

FIG. 11 is a process flow diagram of a contract billing and information cycle according to a preferred embodiment of the present invention.

### DETAILED DESCRIPTION OF THE PREFERRED EMBODIMENT

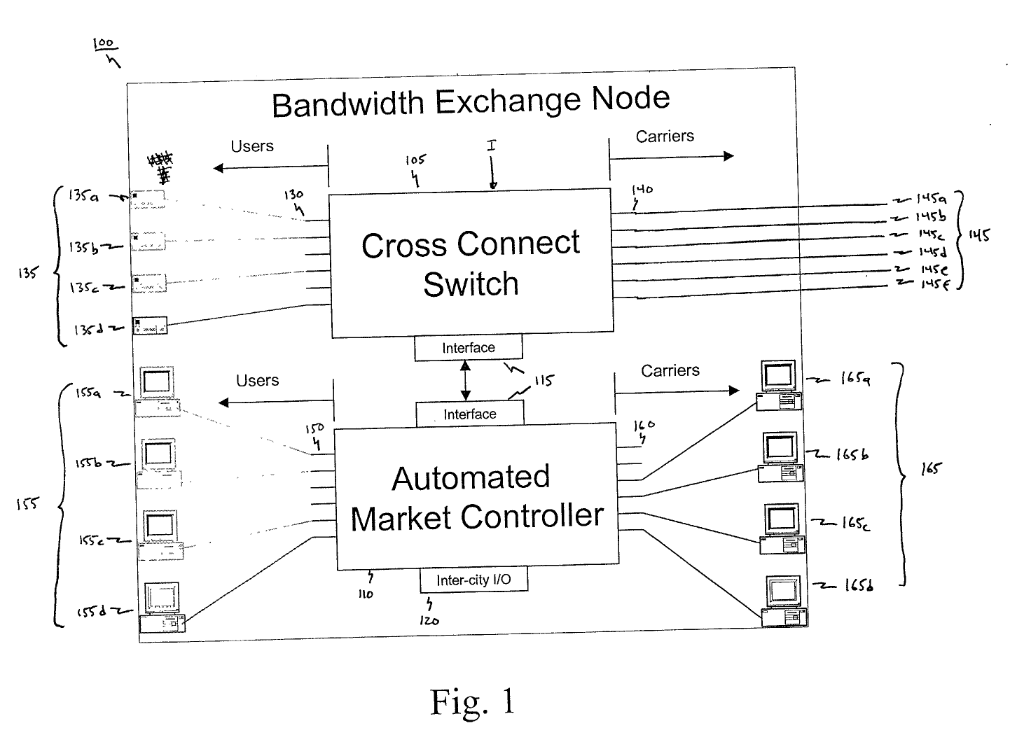

FIG. 1 is a diagram of a bandwidth exchange node using the method and apparatus of a preferred embodiment of the present invention. As shown in FIG. 1, the bandwidth exchange node 100, to which the method and apparatus of the present invention applies, includes a cross connect switching fabric 105, an automated market controller 110, an interface 115, and an inter-city input/output (I/O) device 120.

The cross connect switching fabric 105 includes multiple user connect ports 130 which users connect to the user data networks 135, and multiple carrier connect ports 140 to which carriers connect to multiple telecommunications facilities 145. Although in the disclosed embodiments there are four data user networks 135a-135d and six telecommunications facilities 145a-145f, the number of these elements will likely be much larger, and can vary according to need.

The automated market controller 110 includes user control ports 150 which users connect to user network servers 155, and user control ports 160 to which carriers connect to carrier network servers 165. Although in the disclosed embodiments there are four user network servers 155a-155d and four carrier network servers 165a-165f, the number of these elements will likely be much larger, and can vary according to need.

The cross connect switching fabric 110 has the primary functionality of connecting and switching user connect ports 130 to carrier connect ports 140 at the direction of an external control system input I. For example, a first user at user data network 135a may use a fifth telecommunications carrier 145e for a specific contract interval, and may then use a second telecommunications carrier 145b for the next contract interval. The cross connect switch fabric 110 must therefore be programmable to make such changes with minimal interruption to circuit operation.

The cross connect switch 110 is preferably connected to the automated market controller 110 through the interface 115, and receives programmed change instructions from that system. The automated market controller 110 preferably includes a fault tolerant very high speed computing platform such as a mainframe, distributed computing platform or clustered multiprocessor servers. The users preferably have connections into the automated market controller 110 from their user network servers 155, which host their virtual user agents. The carriers similarly have connections into the automated market controller from their carrier network servers 165, which host their virtual carrier agents.

The minimum virtual agent server would preferably include a microcomputer platform, running an NT, UNIX, LINUX, or the like environment. The automated market controller 110 also may have the means to pass input or output to other automated market controllers through the inter-city I/O device 120.

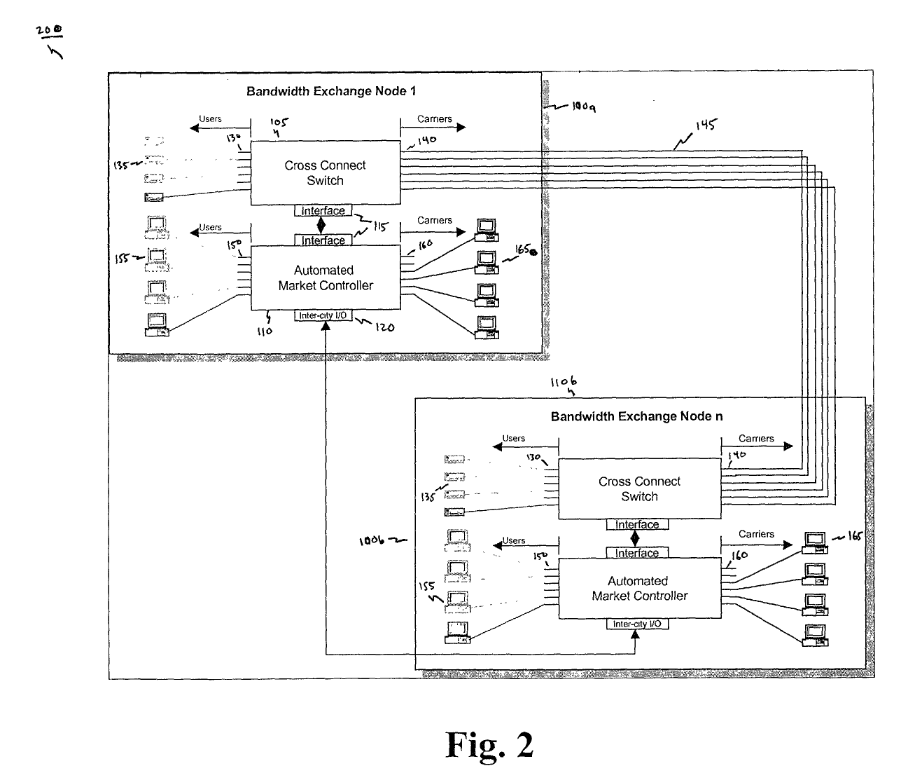

FIG. 2 is a functional diagram of the smallest complete bandwidth exchange node circuit using the method and apparatus of a first preferred embodiment of the present invention. As shown in FIG. 2, the simplest embodiment of the present invention is a two node environment, including a first bandwidth exchange node 100a and a second bandwidth exchange node 100b. This embodiment depicts the provisioning of multiple carrier facilities 145 (also called circuits) between the bandwidth exchange nodes 100a and 100b.

Each node 100a and 100b can have many user connect ports 130 in place and many carrier connect ports 140 as well. Port density is a function of what is available within the telecommunications cross connect switch marketplace and the size of the facilities 145 in place.

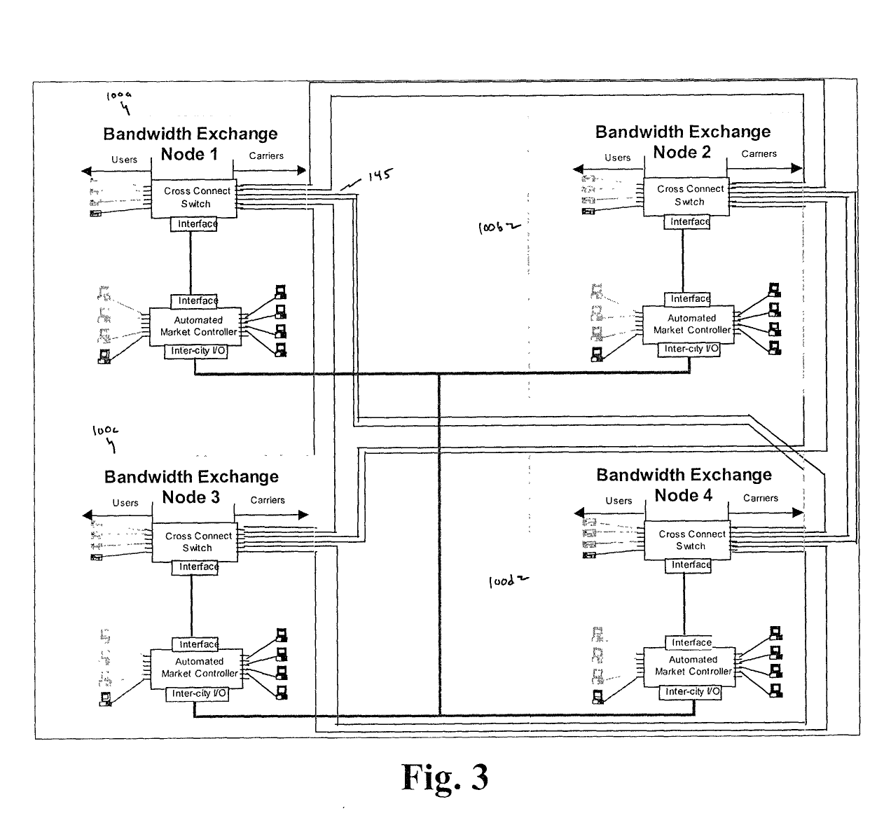

FIG. 3 is a functional diagram of a bandwidth exchange node circuit using the method and apparatus of a second preferred embodiment of the present invention. As shown in FIG. 3, the second preferred embodiment of the present invention is a four node environment, including a first through fourth bandwidth exchange nodes 100a-100d. This embodiment depicts the provisioning of multiple carrier facilities 145 between the four bandwidth exchange nodes 100a-100d. It is anticipated that many hundreds of exchange nodes would be operational in such a system.

In both the first and second preferred embodiments, the automated market controllers 110 in each of the various bandwidth exchange nodes 100a-100d communicate with each other through their respective inter-city I/O devices 120.

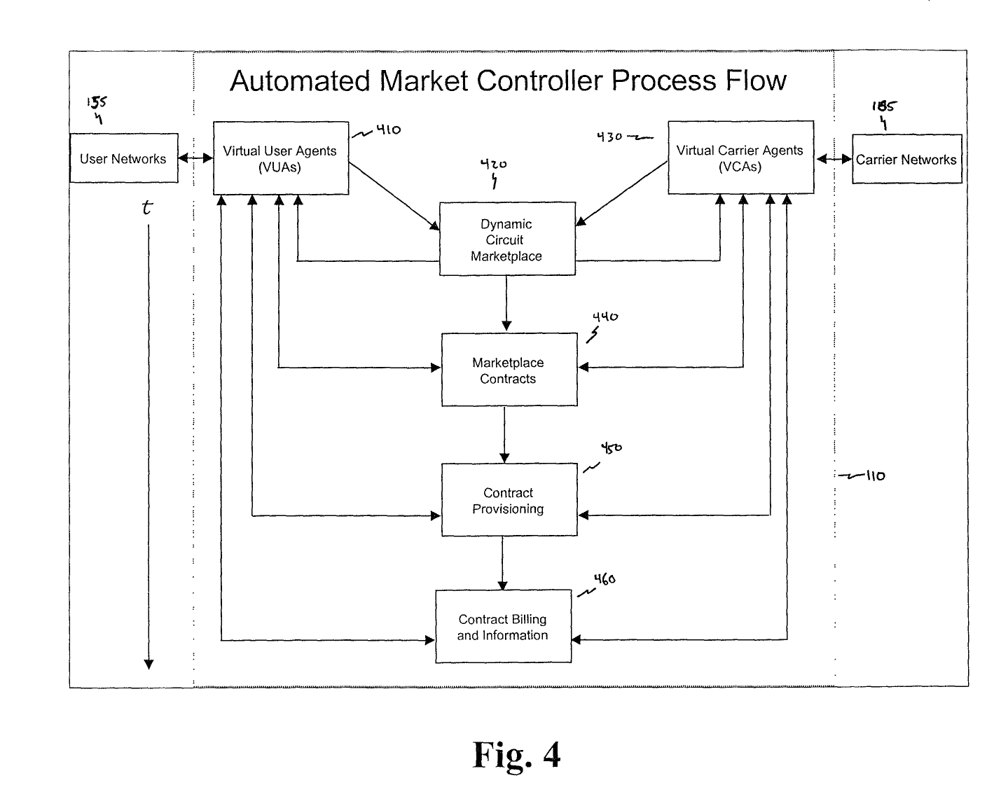

FIG. 4 is a process diagram which details the automated market controller portion 110 of a bandwidth exchange node 100 using the method and apparatus of a preferred embodiment of the present invention. The market controller portion 110 includes a virtual user agent (VUA) module 410, a dynamic circuit marketplace (DCM) module 420, a virtual carrier agent (VCA) module 430, a marketplace contracts module 440, a contract provisioning module 450, and a contract billing and information module 460.

As shown in FIG. 4, the VUA module 410 presents demand-based price bids to the DCM module 420 for node-to-node capacity where required by its host user network 155, for future provisioning. The VCA module 430 presents supply-based price offers to the DCM module 420 for node-to-node capacity as determined by its host carrier network 165 and available facilities 145 between the nodes. When a contract is reached in the DCM module 420, both respective virtual agent modules 410 and 430 are advised, and the contract is passed to the marketplace contracts module 440.

The marketplace contracts module 440 keeps track of all concluded contracts until the contract interval approaches. A contract interval, in this context, is defined as the specific date and time when the contract requires the start of provisioned service. Contracts may be formed many months in advance of the actual required date of performance, immediately prior to need, or at any other desired time. The marketplace contracts module 440 maintains robust records sorted by node and contract interval for contract performance timing.

The marketplace contracts module 440 also maintains records of the contract parties. As the contracts are assignable, the contract itself may be sold to a separate party other than the two who initially made the contract. While the form of the contract remains the same, the user and carrier billing information can be updated to reflect the new owner(s) of the contract if that changes.

When the contract interval approaches, the marketplace contracts module 440 passes the information regarding contracts to be provisioned to the contract provisioning module 450. The contract provisioning module 450 then readies all nodes that need to be changed for the upcoming contract interval, and instructs all relevant cross connect switch fabrics 110 to synchronously change the port-to-port circuit mappings at the correct time.

During the contract interval, the contract provisioning module 450 also monitors contract compliance across all circuits according to the performance standards of each contract, and will make additional changes to the provisioning circuits when a carrier is unable to correct an anomaly. In addition, contract compliance data may be archived and available for audit purposes.

Upon the completion of a contract interval, contract performance information for each contract is passed to the contract billing and information module 460. The contract billing and information module 460 consolidates all contract data by carrier and provides billing feeds in the format preferred by each carrier. Carrier/user-specific contract performance history may be embedded within the data feed, if desired. This module also provides data regarding carrier overall performance for use by the VUA modules 410.

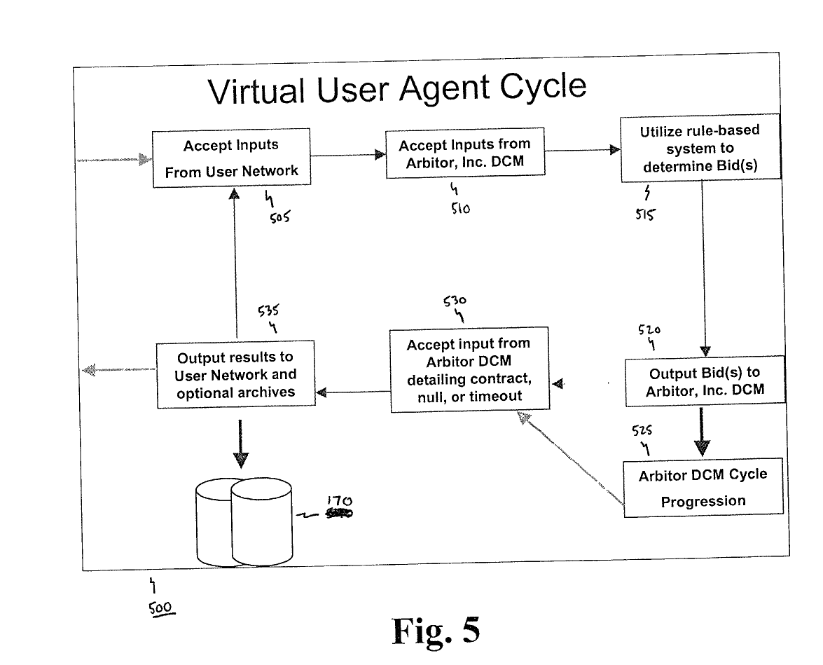

FIG. 5 is a process flow diagram of a virtual user agent cycle according to a preferred embodiment of the present invention. This virtual user agent cycle represents operations performed by the VUA module 410.

As shown in FIG. 5, the virtual user agent (VUA) cycle 500 includes a recurring cycle comprised of the following processes. At the start of the cycle, the VUA module 410 accepts inputs from its related user network 135 as well as updated carrier performance information from the contract billing information module 460 (step 505). The host network inputs could be automatic network requests for immediate (next contract interval) additional bandwidth between nodes, revised VUA programming metrics, or administrative bandwidth requests for future needs.

The VUA module 410 then accepts current inputs from the DCM module 420 as well (step 510), which can include information on the availability of bandwidth, prices offered for the sale of bandwidth, etc.

Then, using its own rule-based algorithm, the VUA module 410 determines whether a bid should be placed, withdrawn, or specific offer accepted (step 515). Bid placement and withdrawal is fairly straightforward, generally working on a simple threshold basis, i.e., is the offer price below a given threshold price? Specific offer acceptance allows the user to accept other than the lowest offer within that particular marketplace, as would be the case when the user had a preferred carrier which they would accept at a higher price.

The VUA module 410 then waits for a predetermined time for input from the DCM module 420, to see if market results will detail contract closure or a null bid (in the case where an existing bid is withdrawn). If so, the VUA module 410 outputs the completed bid or null bid to the DCM module 420 (step 520)

If neither of these conditions are met within a set time, a timeout occurs and the VUA module 410 continues with cycle processing (step 525). This timeout process makes certain that the system will not get hung up due to lack of input. In this case existing market bid/offer listing is received by the VUA module 410.

Regardless of whether there is a completed bid (or null bid), or a timeout, the VUA module 410 then accepts the information relating to contracts, nulls, or timeouts (step 530), from the DCM module 420, and outputs applicable results to the user network 155 and to archives 170 (step 535) before starting the cycle again.

This cycle is preferably delineated in milliseconds and can support hundreds of different bid submittals to the same marketplace per second. For this reason, it is unlikely that direct human access to the bidding floor would result in favorable economics for user networks, as virtual user agents would accept favorable carrier offers long before the human threshold for decision making could play a role.

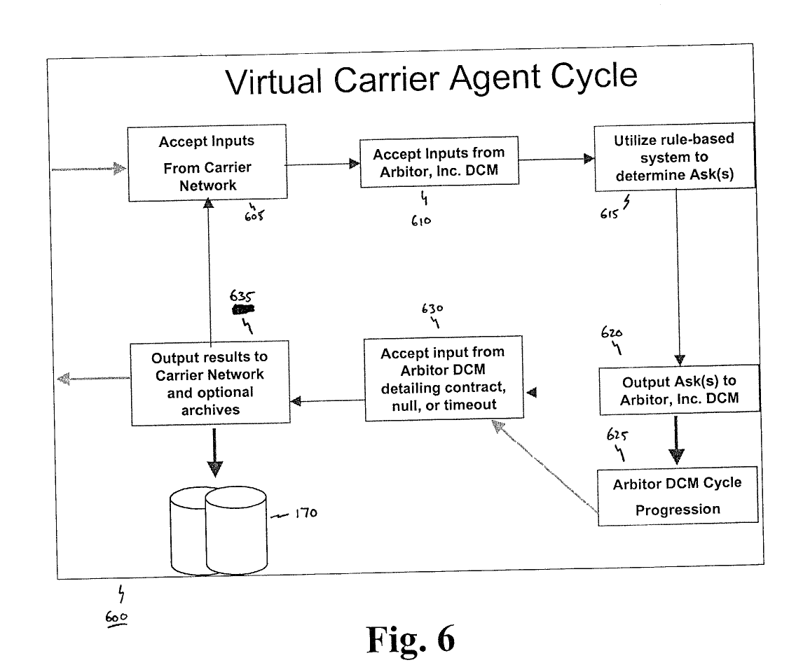

FIG. 6 is a process flow diagram of a virtual carrier agent cycle according to a preferred embodiment of the present invention. This virtual carrier agent cycle represents operations performed by the virtual carrier agent 430.

As shown in FIG. 6, the virtual carrier agent (VCA) cycle 600 includes a recurring cycle having the following processes. At the start of the cycle, the VCA module 430 accepts inputs from its host network, i.e., the carrier network (step 605). The host network inputs could be automatic network loading parameters to determine supply pricing modeling, revised VCA programming metrics, or administrative network base loading parameters for future cash flow planning. The VCA module 430 also accepts current inputs from the dynamic circuit marketplace (step 610).

Then, using its own rule-based algorithm, the VCA module 430 determines whether an offer should be placed, withdrawn, or specific bid accepted (step 615). Offer placement and withdrawal is fairly straightforward, whereas specific bid acceptance allows the carrier to accept other than the highest bid within that particular marketplace, as would be the case when the carrier had a preferred user which they would accept at a lower price. The VCA then waits a predetermined time for input from the dynamic circuit marketplace module, with market results detailing contract closure, null bid (in the case where an existing offer is withdrawn), or timeout where the existing market bid/offer listing is received by the VCA.

The VCA module 430 then waits for a predetermined time for input from the DCM module 420, to see if market results will detail contract closure or a null bid (in the case where an existing bid is withdrawn). If so, the VCA module 430 outputs the completed bid or null bid to the DCM module 420 (step 620)

If neither of these conditions are met within a set time, a timeout occurs and the VCA module 430 continues with cycle processing (step 625). This timeout process makes certain that the system will not get hung up due to lack of input. In this case existing market bid/offer listing is received by the VCA module 430.

Regardless of whether there is a completed bid (or null bid), or a timeout, the VCA module 430 then accepts the information relating to contracts, nulls, or timeouts (step 630), from the DCM module 420, and outputs applicable results to the carrier network 165 and to archives 170 (step 635) before starting the cycle again.

The VCA module 430 then outputs applicable results to the carrier network and to archives (step 635) before starting the cycle again. As with the VUA cycle 500, the VCA cycle 600 is preferably delineated in milliseconds and supports hundreds of different offer submittals to the same marketplace per second. As a result, it is similarly unlikely that direct human access to the market floor would result in favorable economics for carrier networks, as virtual carrier agents would accept favorable carrier bids long before the human threshold for decision making could play a role.

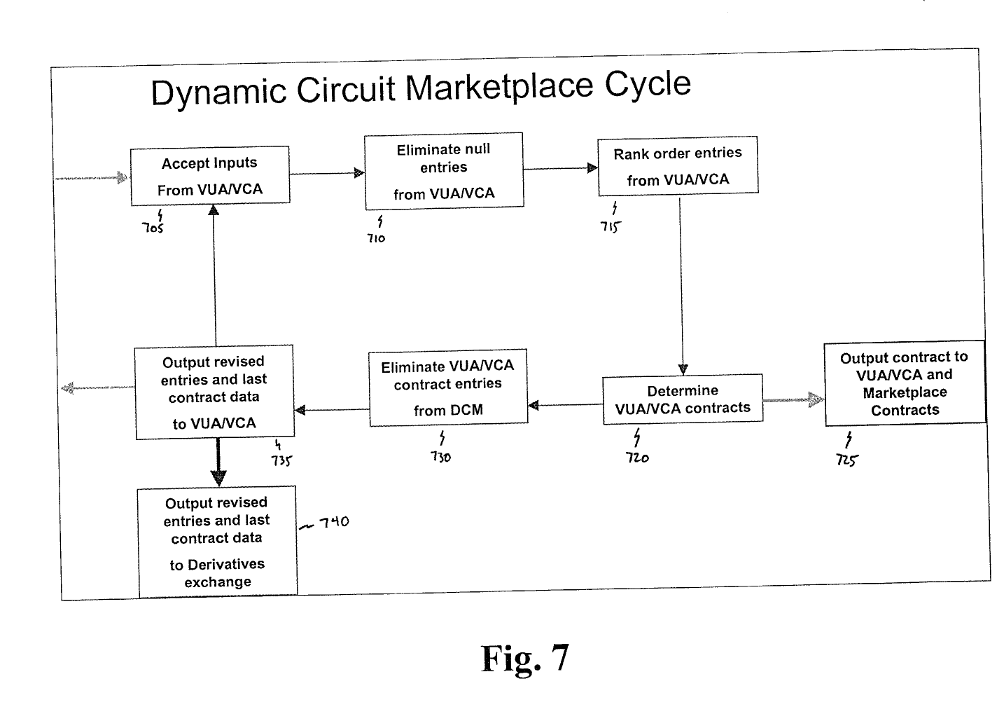

FIG. 7 is a process flow diagram of a dynamic circuit marketplace according to a preferred embodiment of the present invention.

As shown in FIG. 7, the dynamic circuit marketplace (DCM) cycle 700 includes a recurring cycle having the following processes. At the highest level the cycle starts with the DCM module 420 accepting inputs from the VUA modules 410 and VCA modules 430 (step 705). The DCM module 420 then eliminates any null entries, which are used to cancel existing offers and bids (step 710), and ranks the orders of VUA/VCA entries by bandwidth exchange node pairs, bandwidth, contract interval, and pricing (step 715).

A review is then made of contracts being concluded (step 720), with concluded contracts output to the VUA module 410, the VCA module 430, and the marketplace contracts module 440 (step 725). The concluded contract entries are then deleted from the marketplace listings within the DCM module 420 (step 730), and the revised entries together with data of the last contract closed are output to the VUA modules 410 and the VCA modules 430 (step 735).

In addition, the revised entries together with data of the last contract closed are also output to a bandwidth derivatives exchange, i.e., a market information data stream, before starting the cycle again. By having up to date information regarding availability and price of bandwidth provided, a market can grow that will properly value the bandwidth in real time.

As with other cycles, the DCM cycle 700 is also preferably delineated in milliseconds and supports thousands of contracts closed per DCM cycle 700.

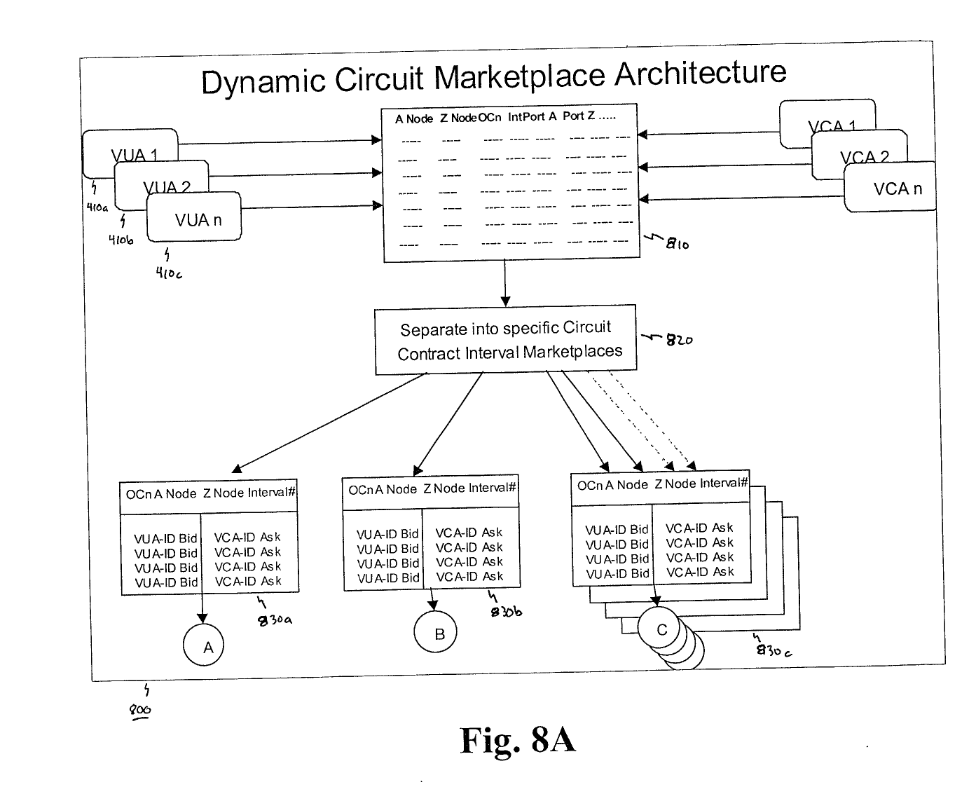

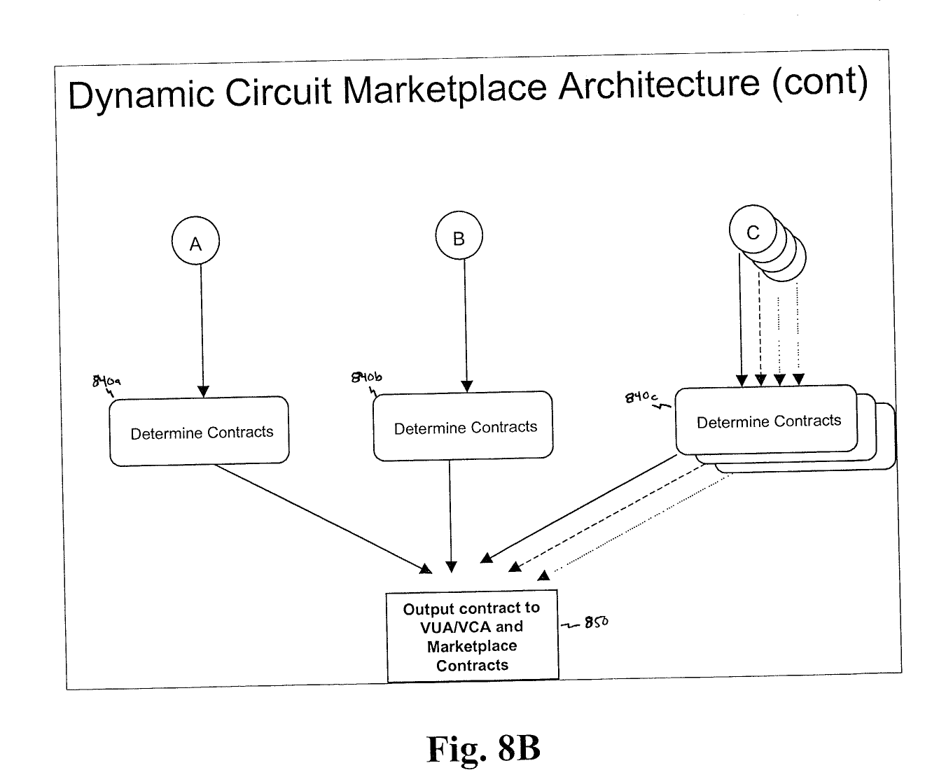

FIGS. 8A and 8B shows the detailed architecture of the DCM processes 800. All VUA modules 410a-410c and VCA modules 430a-430c provide their inputs to a central clearinghouse database 810, with details concerning which bandwidth node is the origin and which is the termination, which bandwidth is desired, which contract interval is desired, which port at each node is needed, which carrier should be referenced, and which user should be referenced. The entries are then separated by distributed software 820 into separate discrete circuit, bandwidth, contract interval marketplaces 830a-830c,where the entries are rank ordered.

Specific offer/bid acceptance is first evaluated 840a-840c in the individual marketplaces, and resulting contracts are created. Those offer/bid entries are removed from further consideration, and a strict bid/offer price analysis is performed. Contracts formed from this process also have their entries removed from the specific marketplace. The formed contracts, both from specific acceptance and price matches, are then consolidated system-wide into one contracts listing, are output to the marketplace contracts module 440 and to the virtual agents which formed the contracts 850.

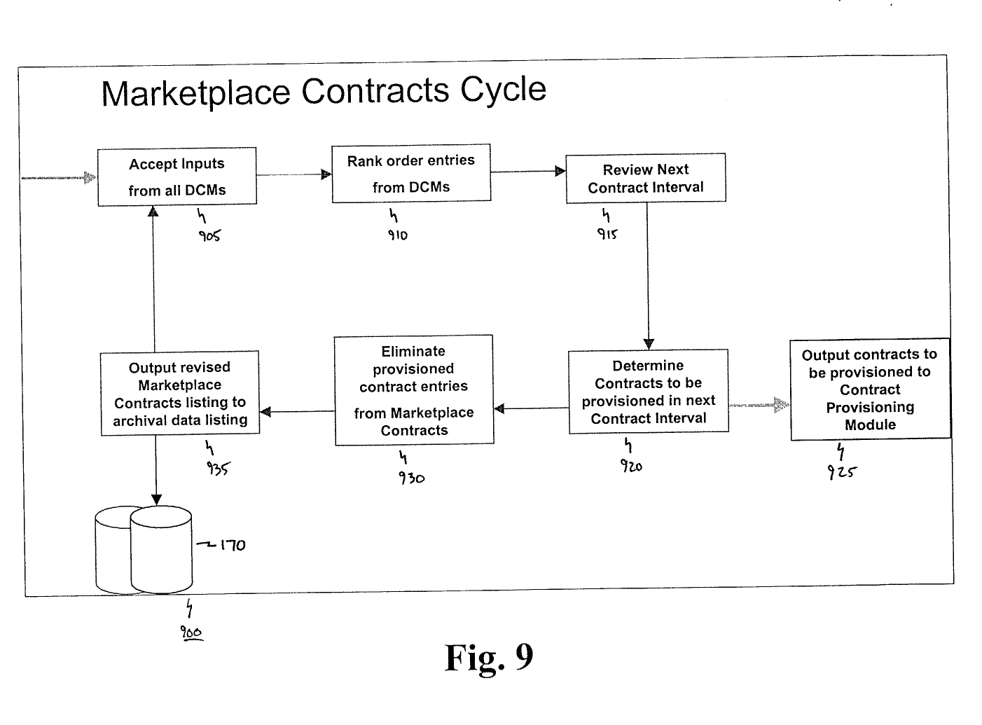

FIG. 9 details the marketplace contracts (MC) cycle 900 which starts by accepting inputs from the dynamic circuit marketplace (DCM) module 420 as well as inputs concerning existing contracts that have been assigned to different users or carriers through the offices of a bandwidth derivatives exchange (step 905). The cycle then rank orders all contracts by contract interval, origin and destination node, bandwidth, and carrier (step 910). Next, the cycle reviews the next contract interval (step 915) and determines which contracts need to be provisioned in the next contracting interval (step 920).

Contracts that are scheduled to be provisioned within the next contract interval are output to the contract provisioning module 450 (step 925). The contracts thus forwarded are eliminated within the MC module 440 (step 930), and the revised listing is time/date stamped and archived within data storage for auditing purposes before starting the cycle again (step 935). When futures contracts exist, data within the MC module 440 can reside for second, weeks, months, etc., before being provisioned.

The MC module 900 requires a robust real-time data storage array with high capacity, as well as significant archival storage 170.

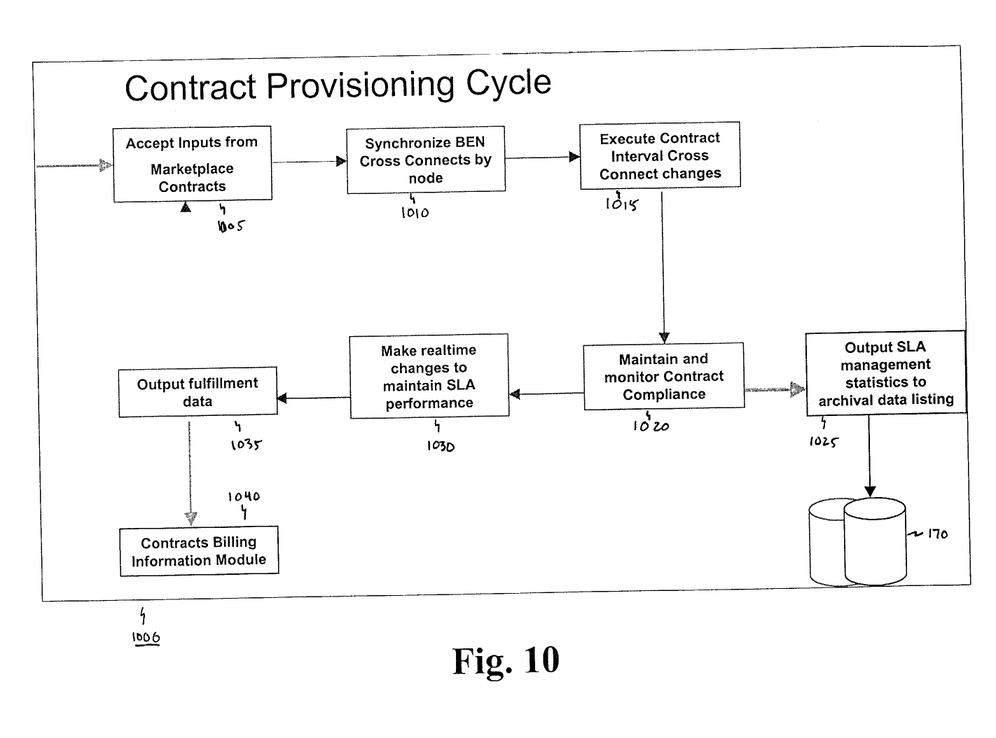

FIG. 10 details the contract provisioning (CP) cycle 1000. AS shown in FIG. 10, in the CP cycle 100, the CP module 450 starts by accepting inputs from the MC module 440 one contract interval prior to a given contract performance date/time (step 1005). The CP module 450 then synchronizes bandwidth exchange nodes (BENs) for each contract (step 1010) so that any cross connect changes can be simultaneous and thus have minimal impact to user data traffic. Once synchronized, the CP module 450 proceeds to execute each contract's required cross connect changes (step 1015).

The CP module 450 then monitors contract compliance for the duration of the contract interval (step 1020), storing service level agreement management statistics to an archival data listing 170 as the interval progresses (step 1025).

Where corrective action is required, the CP module 450 will re-provision the user circuit to an alternate carrier in real-time for the same price in the event that the contracted carrier has a system upset which they cannot recover from in a reasonable time, e.g., less than one minute (step 1030). In that case the contracted carrier will generally bear the cost of any additional charges above the contracted amount which may be charged by the substitute carrier and forfeit the contract price for the affected interval.

Upon contract interval completion, the CP module 450 outputs fulfillment data to the CBI module 460 and begins the cycle once more (step 1035).

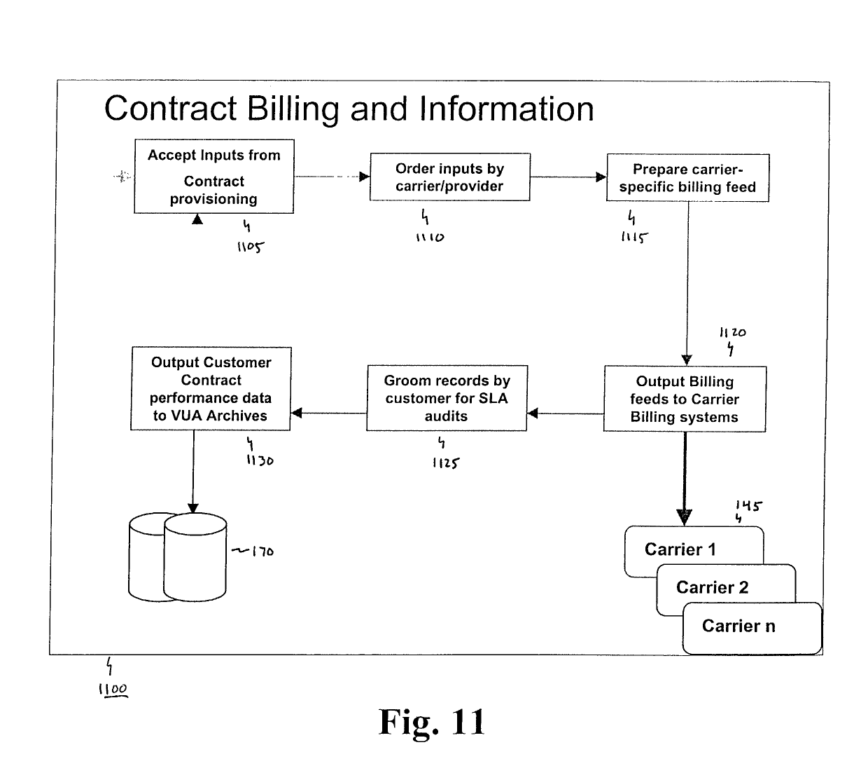

FIG. 11 details a Contract Billing and Information (CBI) cycle. As shown in FIG. 11 in the CBI cycle, the CBI module 460 begins by accepting inputs from the CP module 450 (step 1105) and ordering the fulfillment data by the carrier/provider (step 1110). The CBI module 460 then prepares carrier-specific billing feeds for use with carrier's existing billing platforms (step 1115).

These systems will preferably bill on a monthly basis, so significant billing data storage will be required by the module. However, alternate embodiments may handle billing in a different manner.

When each carrier accepts billing feeds, they are output by this module. The service level agreement (SLA) records are groomed for each user, and are sorted by carrier for SLA audit purposes (step 1125). This data is then output to each VUA module 410 and may also be archived (step 1130). In this step, a real-time global report on each carrier's SLA performance is preferably prepared and distributed to all concerned VUA modules 410 as an ongoing report.

The present invention has been described by way of a specific exemplary embodiment, and the many features and advantages of the present invention are apparent from the written description. Thus, it is intended that the appended claims cover all such features and advantages of the invention. Further, since numerous modifications and changes will readily occur to those skilled in the art, it is not desired to limit the invention to the exact construction and operation ad illustrated and described. Hence, all suitable modifications and equivalents may be resorted to as falling within the scope of the invention.

What is claimed:

1. A method of using a virtual user agent in a computer to automatically provision bandwidth between separate locations, comprising:
accepting user information from one or more user networks, the user information relating to bandwidth need and a maximum user acceptance price;
accepting carrier information from a dynamic circuit marketplace, the carrier information relating to bandwidth availability and a current carrier offer price;
using a rules-based system to compare the user information to the carrier information to determine a bandwidth bid;
providing the bandwidth bid to the dynamic circuit marketplace;
receiving one of a contract output from the dynamic circuit marketplace or a timeout output from an internal clock;
providing information relating to the contract output or the timeout output to the one or more user networks.

2. A method of using a virtual user agent in a computer to automatically provision bandwidth between separate locations, as recited in claim 1, further comprising providing information to an archive relating to the contract output or the timeout output.

3. A method of using a virtual user agent in a computer to automatically provision bandwidth between separate locations, as recited in claim 1, wherein the timeout output is received if no contract output is received after a set timeout time elapses from when the bandwidth bid is provided to the dynamic circuit marketplace.

4. A method of using a virtual user agent in a computer to automatically provision bandwidth between separate locations, as recited in claim 1, wherein the contract output includes contract information indicating a completed contract or null information indicating a failed contract attempt.

5. A method of using a virtual carrier agent in a computer to automatically provision bandwidth between separate locations, comprising:
accepting carrier information from one or more carrier networks, the carrier information relating to bandwidth availability and minimum carrier acceptance price;
accepting user information from a dynamic circuit marketplace, the user information relating to bandwidth need and current user offer price;
using a rules-based system to compare the carrier information and the user information to determine a bandwidth bid;
providing the bandwidth bid to the dynamic circuit marketplace;
receiving one of a contract output from the dynamic circuit marketplace or a timeout output from an internal clock;
providing information relating to the contract output or the timeout output to the one or more carrier networks.

6. A method of using a virtual carrier agent in a computer to automatically provision bandwidth between separate locations, as recited in claim 5, further comprising providing information to an archive relating to the contract output or the timeout output.

7. A method of using a virtual carrier agent in a computer to automatically provision bandwidth between separate locations, as recited in claim 5, wherein the timeout output is received if no contract output is received after a set timeout time elapses from when the bandwidth bid is provided to the dynamic circuit marketplace.

8. A method of using a virtual carrier agent in a computer to automatically provision bandwidth between separate locations, as recited in claim 5, wherein the contract output includes contract information indicating a completed contract or null information indicating a failed contract attempt.

9. A method of using a dynamic circuit marketplace in a computer to automatically provision bandwidth between separate locations, comprising:
accepting user bid information from one or more user agents, the user bid information relating to bandwidth need and current user offer price;
accepting carrier bid information from one or more carrier agents, the carrier bid information relating to bandwidth availability and current carrier offer price;
using a rules-based system to compare the user bid information and the carrier bid information to determine if there is successful bid where the bandwidth availability matches the bandwidth need and the current user offer price matches the current carrier offer price;
eliminating any user bid information and carrier bid information that does not result in a successful bid;
using the rules-based system to rank any remaining user bid information and carrier bid information according to a set ranking scheme;
using the rules-based system to determine completed contracts based on the ranked user bid information and ranked carrier bid information; and
outputting contract information to a marketplace contract module, to the one or more user agents, and to the one or more carrier agents,
wherein the contract information either relates to one of the completed contracts or provides indicates a lack of contract agreement.

10. A method of using a dynamic circuit marketplace in a computer to automatically provision bandwidth between separate locations, as recited in claim 9, wherein the current user offer price and the current carrier offer price are ranges of price.
